(19) United States
(12) Patent Application Publication
(10) Pub. No.: US 2016/0080802 A1
(43) Pub. Date: Mar. 17, 2016

(54) HIGH THROUGHPUT DIGITAL VIDEO BROADCASTING

(71) Applicant: EchoStar Technologies L.L.C., Englewood, CO (US)

(72) Inventors: Bala Subramaniam, Potomac, MD (US); Yanlai Liu, Rockville, MD (US)

(73) Assignee: EchoStar Technologies L.L.C.

(21) Appl. No.: 14/483,400

(22) Filed: Sep. 11, 2014

(51) Int. Cl. H04N 21/438; H04N 21/647; H04N 21/4402; H04N 21/44; H04N 21/61

(52) U.S. Cl. CPC H04N 21/4382; H04N 21/44; H04N 21/6143; H04N 21/6193; H04N 21/440254; H04N 21/647

(57) ABSTRACT

A system includes an antenna and a receiver. The antenna receives an encoded satellite signal having a plurality of frames. The receiver receives the satellite signal from the antenna and iteratively processes each frame a predetermined number of times. The number of times the frame is processed is based at least on part on a characteristic of the frame. Moreover, the receiver terminates frame processing earlier if a condition, associated with the processing of the frame, exists. An example receiver includes a decoder that decodes the satellite signal and extracts data from at least one frame by iteratively processing each frame the predetermined number of times. The receiver further includes a controller that generates a control signal representing the predetermined number of times the decoder is to iteratively process each frame. The controller generates the control signal based at least in part on a characteristic of the frame.

### BACKGROUND

Digital broadcast standards, such as the Digital Video Broadcasting-Satellite-Second Generation (DVB-S2) standard, are used to transmit media content from satellites to receivers in consumers' homes. The media content is received by an antenna and output to the receiver. The receiver processes the received signals and outputs the media content to a television.

Consumers want to view media content in real time and without any distortion. Issues such as waiting for media content to buffer or trying to view content where the video and sound are not synchronized can be frustrating to consumers. Digital broadcast standards use techniques like Forward Error Correction (FEC) to reduce such issues, especially when the issue results from a weak satellite signal.

### BRIEF DESCRIPTION OF THE DRAWINGS

FIG. 1 illustrates an example system for increasing throughput for digital video signals.

FIG. 2 is a block diagram of an example receiver used in the system of FIG. 1.

FIG. 3 is a flowchart of an example process that may be used to increase throughput for digital video signals.

### DETAILED DESCRIPTION

While techniques such as Forward Error Correction can improve signal quality, implementing FEC techniques requires significant computing power, which reduces throughput. One way to supplement the FEC techniques in satellite telecommunications to increase throughput is by manipulating the decoding process based on the likelihood that a particular signal has been sufficiently decoded. In other words, eliminating processing that is unlikely to result in a more accurate signal can increase throughput.

The unnecessary processing can be eliminated at the receiver. The receiver includes has a decoder that decodes satellite signals and extracts data from frames by iteratively processing each frame a predetermined number of times. The frames are transmitted continuously to the receiver, and each frame is associated with a modulation/coding (modcode) number. Frames with different modcode numbers may be received by the receiver. The receiver may rank the modcode numbers by a performance standard such as signal-to-noise ratio (Es/No). The receiver may be configured to receive modcodes at or below a target Es/No ratio. Each receiver may have a certain channel characteristic (e.g., a clear sky, cloudy sky, rain, etc.), which may be related to an Es/No threshold for the receiver. Since the receiver may process frames with different modcodes, and because each modcode has a target Es/No performance requirement, the receiver may execute a fixed number of processing iterations for each frame. Processing of frames with lower Es/No requirements can be terminated earlier, however, than processing of frames with higher Es/No requirements. Thus, the receiver can adaptively allocate iterations saved from early-terminated frames to frames that require more iterations. The number of iterations may be bounded so that, e.g., no incoming frames are lost.

To achieve a target performance, the receiver may include a controller that applies an average number of processing iterations per modcode to the received frames. Rather than use a fixed number of iterations, the controller selects the predetermined number of iterations based at least in part on a characteristic of the frame, such as the Es/No ratio. For instance, the controller may cease the processing iterations when the Es/No ratio is stronger than required for the modcode associated with the frame. Moreover, the controller can terminate frame processing earlier if a condition, associated with the processing of the frame, exists. Examples of conditions may include information bits and parity bits changing relative to a previous iteration of the frame, each bit node in the frame passes an even parity check, or a buffer fill level exceeding a threshold level. The controller, therefore, is able to adaptively allocate processing iterations for each frame, and may allocate more or fewer iterations to frames based on the signal-to-noise ratio associated with the modcode of the frame. Overall, the receiver may aim to maintain a positive iteration balance, meaning that the receiver may process each frame, on average, faster than without any adaptive iteration allocation.

The system shown in the FIGS. may take many different forms and include multiple and/or alternate components and facilities. The exemplary components illustrated are not intended to be limiting. Indeed, additional or alternative components and/or implementations may be used.

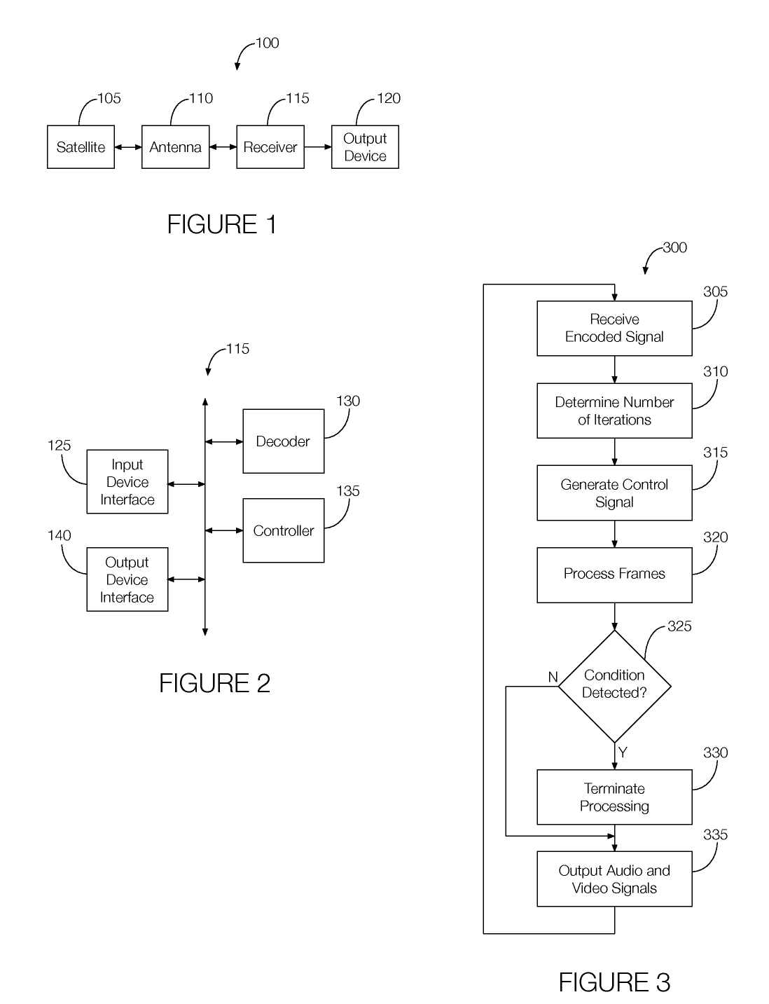

As illustrated in FIG. 1, the system 100 includes a satellite 105, an antenna 110, a receiver 115, and an output device 120.

The system 100 may include any number of satellites 105. Each satellite 105 may be in orbit around the Earth and configured to receive a signal from a terrestrial broadcast station (not shown). The satellites 105, therefore, may be configured to receive and transmit the signals received from the broadcast station back to Earth. The satellite 105 may be configured to receive and rebroadcast signals carrying data associated with media content. The signals may be transmitted using a protocol such as the Digital Video Broadcasting-Satellite-Second Generation (DVB-S2) format. The signals may include video data, audio data, or both. Prior to transmission, the satellite 105 may encode the signals for, e.g., error correction purposes. The signals may be encoded with a low-density parity-check (LDPC) code or another type of linear error correcting code. The encoded signals may transmit data in frames assembled into packets. Each frame may be associated with a modulation/coding (modcode) number. Different frames may be associated with different modcode numbers, and each modcode number may be associated with a particular performance requirement such as a signal-to-noise (Es/No) ratio. Moreover, to reduce errors, the satellite 105 may transmit redundant data in some or all of the frames.

The antenna 110 may be configured to receive signals transmitted from one or more satellites 105 in accordance with a satellite telecommunications protocol. The antenna 110 may receive signals from any number of satellites 105, and some or all of the received signals may be passed to the receiver 115 for processing. As discussed above the signals transmitted by the satellite 105, and thus received by the antenna 110, may be encoded.

The receiver 115 may be configured to process the encoded signals received from the antenna 110. Processing the encoded signals may include decoding the signals, extracting data from frames from each packet received, processing the frames, and outputting the audio and video signals to the output device 120. The receiver 115 may be configured to iteratively process each frame a predetermined number of times. Processing each frame multiple times increases the certainty about the contents of the frame. That some or all frames include redundant data further increases certainty.

As discussed above, each frame may be associated with a modcode number that may indicate a performance requirement, such as a signal-to-noise (Es/No) ratio. The receiver 115 may be configured to process each frame a sufficient number of iterations so that the processed frame meets the Es/No requirements of the receiver 115. Because different frames have different modcode numbers, and thus different Es/No ratios, the receiver 115 may be configured to process some frames with more or fewer iterations than others. For instance, a frame with a modcode that is associated with a high Es/No ratio may require more iterations than a frame with a modcode associated with a low Es/No ratio.

The receiver 115 may increase throughput by adaptively applying different numbers of processing iterations to different frames. Since processing the frames takes time, and because the receiver 115 may only have a limited amount of time to spend on each frame, the receiver 115 may be configured to allocate a certain number of iterations to each frame based on the frame's modcode number. More iterations may be allocated to frames with modcode numbers that require a higher Es/No ratio and fewer iterations may be allocated to frames with modcode numbers that allow for a smaller Es/No ratio. Additional iterations (e.g., iterations not used to process a frame with a modcode number associated with a low Es/No ratio) may be allocated to future frames (i.e., frames that have not been received yet) or previously received frames (i.e., frames that required additional processing). By adaptively applying different numbers of processing iterations to different frames, the receiver 115 may achieve higher throughput than if the receiver 115 were to simply apply the same number of iterations to every frame.

The output of the receiver 115 may include video signals, audio signals, or both. The audio and video signals may be transmitted to the output device 120, such as a television or other display. The media content, therefore, may be presented to a viewer.

Referring to FIG. 2, the receiver 115 may include an input device interface 125, a decoder 130, a controller 135, and an output device interface 140.

The input device interface 125 may be configured to receive the encoded signals from the antenna 110. The input device interface 125 may be configured to pass received signals to, e.g., the decoder 130.

The decoder 130 may be configured to process the encoded signals received from the antenna 110 via, e.g., the input device interface 125. To process the signals, the decoder 130 may be configured to extract frame data from the encoded signal and process each frame a predetermined number of times according to the modcode number and target Es/No ratio of the frame. The number of processing iterations may be based on a control signal provided to the decoder 130 from the controller 135. The decoder is discussed in greater detail below.

The controller 135 may be configured to determine how many processing iterations are sufficient to accurately process the frame. The controller 135 may be configured to consider factors such as the modcode number of each frame and the performance requirements associated with the modcode number (e.g., Es/No ratio) when determining how many iterations to apply to the frame. The controller 135 may be configured to output a control signal to the decoder 130 that commands the decoder 130 to stop processing a particular frame after a certain number of iterations, or alternatively, to only execute a particular number of iterations when processing the frame.

The controller 135 may be further configured to monitor the iteration balance. Each iteration takes a predetermined amount of time, and the receiver 115 only has a limited amount of time to process each frame to maintain a minimum throughput. Iteration balance may refer to the difference of the total possible number of iterations that could be performed to number of iterations actually performed. Iteration balance can be a positive or negative value. Positive iteration balances may indicate a temporary increase in throughput while a negative iteration balance may indicate a temporary decrease in throughput.

The controller 135 may be configured to command a positive iteration balance as often as possible. For example, the controller 135 may allocate fewer iterations for frames with lower Es/No ratio requirements and more iterations for frames with higher Es/No ratio requirements. The controller 135 may continually monitor the iteration balance and allocate iterations accordingly with the ultimate goal of having a positive iteration balance.

The controller 135 may monitor the iteration balance relative to an input buffer. If the fill level of the input buffer reaches a certain threshold level, which may occur if a particular frame has a modcode number that demands an excessive number of iterations, the controller 135 may stop processing the current frame and instead begin to process the next and subsequent frames according to the paradigm described above, at least until the buffer exceeds the threshold level again.

The output device interface 140 may be configured to output the video and audio signals to the output device 120. The output device interface 140 may be configured to output signals according to any number of protocols. Examples of protocols may include the High-Definition Multimedia Interface (HDMI) protocol, S-video, composite video, component video, mono or stereo audio, or any other digital or analog video or audio standard.

FIG. 3 is a flowchart illustrating an example process 300 that may be implemented by the receiver 115 to increase throughput by maintaining a positive iteration balance.

At block 305, the decoder 130 may receive the encoded signal. The encoded signal may be transmitted from the satellite 105 to the antenna 110, and passed from the antenna 110 to the receiver 115. The receiver 115 may receive the encoded signal from the antenna 110 via the input interface device, which may pass the encoded signal to the decoder 130. The encoded signal may include frames containing video data, audio data, or both, associated with a media content instance.

At block 310, the controller 135 may determine how many iterations the decoder 130 should apply to each frame received at block 305. The number of iterations may be associated with various criteria. Each frame is associated with a modcode number, which in turn may be associated with a target Es/No ratio. The number of iterations may be based on the modcode number, and particularly, the number of iterations needed for a frame with the modcode number to achieve the target Es/No ratio. Thus, frames associated with higher Es/No ratios may require more iterations than frames associated with lower Es/No ratios.

At block 315, the controller 135 may generate and output a control signal. The control signal may command the decoder 130 to execute a particular number of processing iterations when processing the frames for, e.g., error correction purposes. In one possible approach, the control signal, indicating the number of iterations, may be transmitted before the decoder 130 begins to process each frame. Alternatively, the decoder 130 may begin processing the frames, and the control signal may command the decoder 130 to stop processing either immediately or after a certain number of iterations. As discussed above with reference to block 310, the number of iterations may be based on the modcode number, the target Es/No ratio, or both.

At block 320, the decoder 130 may process the frames according to the control signal. The decoder 130 may perform the number of iterations represented by the control signal, or alternatively, stop processing upon receipt of the control signal if receipt of the control signal indicates that the particular number of iterations has occurred.

At decision block 325, the controller 135 may detect whether a particular condition, associated with the processing of the frame, exists. Examples of conditions may include information bits and parity bits changing relative to a previous iteration of the frame, each bit node in the frame passes an even parity check, or a buffer fill level exceeding a threshold level. If the condition exists, the process 300 may continue at block 330. Otherwise, the process 300 may proceed with block 335.

At block 330, the controller 135 may terminate processing of the frame before, e.g., the predetermined number of iterations have been executed, resulting in “unused” iterations (i.e., the difference between the predetermined number of iterations and the number of iterations executed). The number of unused iterations may be allocated to other frames, such as those that may require more than the predetermined number of iterations.

At block 335, the decoder 130 may output the decoded audio and video signals to the output device interface 140 for further processing and output to the output device 120, such as a television. After block 335, the process 300 may return to block 305. The process 300 may continue to execute until, e.g., the receiver 115 is turned off or no encoded signal is received from the satellite 105.

The decoder 130 may be configured to support both enhanced layered belief decoding (enhanced LBD) and standard belief decoding (SBD). The decoder 130 may be configured to receive data from a de-interleaver at a rate of, e.g., 1175 Mbps or LBD or 225 Mbps for SBD. Components of the decoder 130 may include an input buffer, LIFO or FIFO module, edge RAM, a datapath engine, a sequencer, a channel BER calculator, and decision RAMs.

The decoder 130 may be configured to terminate frame processing at or before reaching a maximum number of iterations. Early termination may occur when, e.g., two conditions have been satisfied. The first condition may include whether there has been no change in both information bits and parity bits relative to a previous iteration. The second condition may include when an even parity check is passed across all edges for each bit node in an entire frame.

Where early termination is not warranted, the decoder 130 may process blocks at a rate of, e.g., 235 Mbps for up to a 32APSK mode by running the decoder 130 at a certain number of iterations, such as ten (10) or eleven (11) iterations. The maximum number of iterations may depend on the code rate. With early termination, the time saved can be used for other codeblocks for performance improvement.

The decoder 130 increases throughput by implementation of several mechanisms. First, codeblocks with undecodeable modcodes will not be decoded. Such blocks will be discarded, freeing up one frame's idle time for processing of other blocks. Moreover, the input buffers may fill at the channel bit rate. The transfer from the demodulator is not instantaneous. Higher order modulations may fill the buffers more quickly. The decoder 130 may be configured to wait until the entire frame has been received and is ready for processing before beginning to decode the frame.

In response to an early termination, iterations left over from the processing may be applied to a subsequent frame to be processed, resulting in a reduction in power for busts that terminate early and better performance for processed frames since some code blocks may receive more iterations to achieve performance requirements.

When code blocks are discarded, the decoder 130 may allow iterations of a current burst to continue up to the available time. In other words, the processing may not stop when backward borrowed iterations are used. This may be most beneficial when the subsequent frame is of the same or higher modulation than the previous frame. One benefit of this type of forward timing borrowing may include maximizing Es/No performance.

The criteria for borrowing iterations may be based on the configuration of the decoder 130 and the buffer fill status of the deinterleaver. For each frame, the decoder 130 may consider various criteria for determining whether to stop borrowing iterations. For example, the decoder 130 may terminate borrowing if the maximum number of iterations, as defined by the configuration register for the modcode, is reached. If not, the decoder may consider whether the modulation of the current frame is the same or higher relative to that of the next frame and whether there is enough time for one or more iterations by checking the fill up speed of the buffer. If the buffer fill level is greater than a predetermined threshold, the decoder 130 may terminate the iterating.

In general, computing systems and/or devices discussed above may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system comprising:
an antenna configured to receive an encoded satellite signal having a plurality of frames;
a receiver configured to receive the encoded satellite signal from the antenna and processes each frame a predetermined number of iterations based at least on part on a characteristic of the frame,
wherein the receiver is configured to terminate processing of at least one frame before executing the predetermined number of iterations in response to detecting at least one condition associated with the processing of the frame.

2. The system of claim 1, wherein the at least one condition includes at least one of:
information bits and parity bits changing relative to a previous iteration of the frame;
each bit node in the frame passes an even parity check; and
a buffer fill level exceeding a threshold level.

3. The system of claim 1, wherein the characteristic is based at least in part on a modulation/coding number associated with the frame.

4. The system of claim 3, wherein the modulation/coding number is associated with a target signal-to-noise ratio.

5. The system of claim 1, wherein the receiver is configured to allocate iterations based on a modulation/coding number associated with each frame, wherein a first modulation/coding number is associated with a first signal-to-noise ratio and a second modulation/coding number is associated with a second signal-to-noise ratio.

6. The system of claim 5, wherein the receiver is configured to allocate more iterations to frames associated with the first signal-to-noise ratio and fewer iterations to frames associated with the second signal-to-noise ratio.

7. The system of claim 1, wherein the receiver is configured to allocate processing iterations associated with a first frame to the predetermined number of iterations associated with a second frame.

8. The system of claim 7, wherein the receiver is configured to determine a difference between the predetermined number of iterations and a number of iterations executed before terminating the processing of the second frame.

9. A receiver comprising:
a decoder configured to decode a satellite signal and extract data from at least one frame by processing each frame a predetermined number of iterations; and
a controller configured to generate a control signal representing the predetermined number of iterations, wherein the controller is configured to generate the control signal based at least in part on a characteristic of the frame and terminate processing of at least one frame before executing the predetermined number of iterations in response to detecting at least one condition associated with the processing of the frame.

10. The receiver of claim 9, wherein the at least one condition includes at least one of:
information bits and parity bits changing relative to a previous iteration of the frame;
each bit node in the frame passes an even parity check; and
a buffer fill level exceeding a threshold level.

11. The receiver of claim 9, wherein the characteristic includes a modulation/coding number associated with the frame.

12. The receiver of claim 11, wherein the modulation/coding number is associated with a target signal-to-noise ratio.

13. The receiver of claim 9, wherein the controller is configured to allocate iterations based on a modulation/coding number associated with each frame, wherein a first modulation/coding number is associated with a first signal-to-noise ratio and a second modulation/coding number is associated with a second signal-to-noise ratio.

14. The receiver of claim 13, wherein the controller is configured to allocate more iterations to frames associated with the first signal-to-noise ratio and fewer iterations to frames associated with the second signal-to-noise ratio.

15. The receiver of claim 9, wherein the controller is configured to allocate processing iterations associated with a first frame to the predetermined number of iterations associated with a second frame.

16. The system of claim 15, wherein the controller is configured to determine a difference between the predetermined number of iterations and a number of iterations executed before terminating the processing of the second frame.

17. A method comprising:
receiving an encoded satellite signal having data contained in at least one frame;
determining a number of processing iterations based at least in part on a characteristic of the frame;
commanding a decoder to process the frame the determined number of processing iterations;
detecting at least one condition associated with the processing of the frame; and
terminating the processing of the frame before executing the predetermined number of processing iterations if the at least one condition is detected.

18. The method of claim 17, wherein detecting the at least one condition includes detecting at least one of:
information bits and parity bits changing relative to a previous iteration of the frame;
each bit node in the frame passing an even parity check; and
a buffer fill level exceeding a threshold level.

19. The method of claim 17, further comprising allocating processing iterations associated with a first frame to the predetermined number of iterations associated with a second frame.

20. The method of claim 19, wherein allocating processing iterations includes determining a difference between the predetermined number of iterations and a number of iterations executed before terminating the processing of the second frame.
